(19) United States
(12) Patent Application Publication
(10) Pub. No.: US 2023/0279259 A1
(43) Pub. Date: Sep. 7, 2023

(54) ASPARTIC POLYUREA COATING

(71) Applicant: SHENZHEN FEIYANG PROTECH CORP., LTD, Shenzhen (CN)

(72) Inventors: Longhui ZHU, Shenzhen (CN); Jun XUE, Shenzhen (CN); Xiaoyong QIU, Shenzhen (CN); Wenzhang LV, Shenzhen (CN); Feiyun HE, Shenzhen (CN); Poli ZHAO, Shenzhen (CN); Haixin HUANG, Shenzhen (CN)

(21) Appl. No.: 18/196,964

(22) Filed: May 12, 2023

Related U.S. Application Data
(63) Continuation of application No. PCT/CN2023/071078, filed on Jan. 6, 2023.

(30) Foreign Application Priority Data
Jan. 26, 2022 (CN) 202210094979.8

(51) Int. Cl. C09D 175/02

(52) U.S. Cl. CPC C09D 175/02; C08K 13/02

(57) ABSTRACT

The present application relates to a field of anti-corrosion coating, in particular, relates to an aspartic polyurea coating including a polyaspartic acid ester: 36%-60%; a ketoimine: 4%-8%; a dispersant: 0.5%-1.0%; an organotin catalyst: 0.1%-0.2%; a titanium white powder: 0%-48%; a thixotropic agent: 0.2%-1.0%; a leveling agent: 0.05%-0.3%; an antifoamer: 0.1%-1.0%; an antiager: 0%-3.0%; a coupling agent: 0%-5%; a diluent: 0%-10% and component B isocyanate curing agent.

### CROSS REFERENCE TO RELATED APPLICATION

This application is a continuation of PCT application serial no. PCT/CN2023/071078, filed on Jan. 06, 2023, which claims the priority and benefit of Chinese patent application no. 202210094979.8, filed on Jan. 26, 2022. The entireties of PCT application serial no. PCT/CN2023/071078 and Chinese patent application no. 202210094979.8 are hereby incorporated by reference herein and made a part of this specification.

### TECHNICAL FIELD

The present application relates to a field of coating, in particular, relates to an aspartic polyurea coating and a preparation method thereof.

### BACKGROUND ART

According to a regulation of “GB 37822-2019 Standard for Fugitive Emission of Volatile Organic Compounds”, when using products containing VOCs (volatile harmful gases) with a proportion of greater than or equal to 10% by mass, a using process should be carried out in a closed equipment or a closed space, and a waste gas should be discharged to a VOCs waste gas collection and treatment system. A local gas collection measure should be taken, and the waste gas should be discharged to the VOCs waste gas collection and treatment system, if a sealing cannot be achieved. This standard poses a great challenge for outdoor anti-corrosion construction.

At present, a most classic anti-corrosion coatings on the market are epoxy coatings and polyurethane coatings. The epoxy coatings have advantages of strong adhesion of film, good tolerance for substrate and high corrosion resistance. The polyurethane coatings have advantages of good weather resistance and good workability. However, conventional epoxy coating and polyurethane coating have low solid content, only 50% - 70%. A low solid content means high solvent content, and the solvent in the coating is generally VOCs including benzene, ketones, esters, ethers and other solvents, and is an important precursor of secondary pollutants such as fine particulate matter (PM2.5) and ozone (O3). Therefore, it is difficult to meet an emission standard of outdoor construction for conventional solvent-based and high-VOCs epoxy coatings and polyurethane coatings, whose waste gas collection and treatment has a high cost, so the conventional solvent-based and high-VOCs epoxy coatings and polyurethane coatings will be gradually replaced by low-VOCs and environment-friendly aspartic polyurea coatings.

The aspartic polyurea coating is a bi-component coating, which includes a mixture with component A polyaspartic acid ester as a main body and a curing agent with component B isocyanate as the main body. This coating has excellent properties and advantages such as high solid content, good environmental protection property, high mechanical property, strong adhesion and good weather resistance. The solid content is generally greater than 80%, and even can reach 100%, i.e., solvent-free. In particular, a coating prepared with polyaspartic acid ester F420 as the main body has a fast drying speed and a high solid content, but short activation period, resulting in a short service life. However, for a coating prepared with polyaspartic acid ester F520 as the main body, a solid content in an airless spraying process can reach greater than 85%, and even a solvent-free construction can be achieved by using a bi-component airless spraying machine with heating function, and the activation period is long. However, this coating has a slow drying speed during the construction process.

### SUMMARY

Regarding to the defects described above, the present application provides an aspartic polyurea coating and a preparation method thereof.

In a first aspect, the present application provides an aspartic polyurea coating includes a mixture and an isocyanate curing agent, in which the mixture includes the following components by weight:

a polyaspartic acid ester: 36%-60%; a ketoimine: 4%-8%; a dispersant: 0.5%-1.0%; an organotin catalyst: 0.1%-0.2%; a titanium white powder: 0%-48%; a thixotropic agent: 0.2%-1.0%; a leveling agent: 0.05%-0.3%; an antifoamer: 0.1%-1.0%; an antiager: 0%-3.0%; a coupling agent: 0%-5%; and a diluent: 0%-10%, based on a total weight of the mixture.

In the above technical solution, under the premise of strictly controlling an moisture content of polyaspartic acid ester, on one hand, the -NCO group of the curing agent is activated by the organotin catalyst, cooperated with ketoimine, then the carbon atom of the curing agent has more reactive activation in an activated state, thereby improving the drying speed of the coating surface. On the other hand, in a process of applying the coating to a surface of a substrate to form a film, the coating contacts the water in the air, and the ketoimine in the film is able to freely absorb the water in the air, and is combined with water to form polybasic primary amine, which quickly reacts with isocyanate curing agent, thus the drying speed of the coating can be improved.

Further, a hydroxyl of polyaspartic acid ester is combined with a hydrophobic end of the coupling agent, and a hydroxyl end of the coupling agent is combined with the surface of the substrate, so that a stable cross-linked network structure is formed, an adhesion and a hydrophobic property of the coating is improved, and a surface tension of polyaspartic acid ester is reduced. Meanwhile, with assistance from the dispersant, the thixotropic agent, the leveling agent, the antifoamer and other components, the aging resistance of the coating is further improved.

In some embodiments, the mixture further includes a water absorbent being present in a proportion of 1%-3% by weight based on a total weight of the aspartic polyurea coating.

In the above technical solutions, the water in the polyaspartic acid ester coating is removed by a physical adsorption of the water absorbent, so that an early hydrolysis of ketoimine in the coating to form a polyamines is avoided.

In some embodiments, the polyaspartic acid ester includes F520 (commercially available from Shenzhen Feiyang Protech Corp., Ltd) and F2850 (commercially available from Shenzhen Feiyang Protech Corp., Ltd); F520 is present in a proportion of 32%-60% by weight based on a total weight of the aspartic polyurea coating; F2850 is present in a proportion of no greater than 4% by weight based on the total weight of the aspartic polyurea coating.

In the above technical solutions, F520 and F2850 are used as main components of the mixture with polyaspartic acid ester as the main body. In particular, F520 has a long activation period, 100% of solid content, excellent weather resistance and high mechanical properties, but has a viscosity of 900-2000 cps. And the coating with F520 as a main resin at 90% solid content has a viscosity of about 1000 cps. F2850 has a low viscosity of 80-140 cps and 100% solid content, but has a short activation period. Thus, in the present application, the viscosity of the coating is reduced by adding F2850. It can be seen from experiments that the viscosity of the coating can be reduced to 400 cps at 90% solid content by adding 4% of F2850. At the same time, because the amount of F2850 added is small, the effect of F2850 added on the activation period is not significant.

In some embodiments, the ketoimine is prepared by condensation of a ketone and a polyamine, and the polyamines is at least one selected from a group consisting of 4,4′-diaminodicyclohexylmethane, 3,3′-dimethyl-4,4′-diaminodicyclohexylmethane, 1,5-diamino-2-methylpentane, isophorondiamine, 4-methylcyclohexane-1,3-diamine and polyetheramine D230 (commercially available from BASF).

In the above technical solutions, activities of two primary amine groups in isophorondiamine are different, and the hydrolysis rates of ketoimine groups therein are also different. When encountering water, the ketoimine group with higher activity absorbs water, is deblocked, and forms one primary amine group first. Only the ketoimine group with higher activity can be deblocked first, before the water molecules introduced reach half amount of water molecules needed for completely deblocking all the ketoimine groups. Therefore, the primary amine reacts with isocyanate rapidly, which is equivalent to a monofunctional grafting, without forming a two-dimensional or three-dimensional network. The molecular weight will not increase significantly, and the viscosity of the system will not increase significantly as well. Only when the ketoimine group with higher activity is completely deblocked after water absorption, the ketoimine group with lower activity begins to be deblocked. At this time, the molecular weight increases rapidly because of a bifunctional grafting. Therefore, the ketoimine made from isophorondiamine can achieve a rapid water absorption and deblocking after mixing the two components of the aspartic polyurea coating, maintaining a long service life, and obtain a faster drying speed after applying the coating on the surface of the substrate.

In some embodiments, the dispersant is at least one selected from a group consisting of an anionic dispersant, a cationic dispersant, a non-ionic dispersant, a zwitterionic wetting dispersant, an electrically neutral wetting dispersant, a polymer hyperdispersant and a free radical hyperdispersant, preferably, a polymer hyperdispersant BYK163 (commercially available from BYK-Chemie GmbH).

In the above technical solutions, on one hand, the dispersant can wet pigments and fillers, so as to improve a grinding efficiency of the pigments and fillers, and avoid agglomeration or flocculation after dispersion of the pigments and fillers, and effectively reduce the viscosity of the coating. On the other hand, one end of an anchoring group in the dispersant is wrapped by the pigments and fillers, and the other end of an anchoring group is bounded with polyaspartic acid ester resin, so that a dispersion system with good uniformity and stability is formed. Further, the dispersant also has effects of improving a leveling, improving an appearance of the film, and improving a thermal stability and the aging resistance of the film, in an aspartic polyurea system.

In some embodiments, the thixotropic agent is at least one selected from a group consisting of fumed silica, organic bentonite, castor oil and polyamide, preferably, fumed silica.

In the above technical solutions, when the coating is still, a shear force is very low or zero, and the viscosity is high, which indicates a storage stability of the coating. During a mixing process, the coating is subject to a high shear force, and the viscosity thereof is reduced, an excellent fluidity of the coating is ensured, which is helpful for construction. In particular, by using fumed silica as the thixotropic agent, an occurrence of stable bubbles can be prevent, and the appearance and a compactness of a thick film is ensured.

In some embodiments, the antifoamer is at least one selected from a group consisting of BYK085, BYK024 and BYK093(commercially available from BYK-Chemie GmbH).

In the above technical solutions, the antifoamer is incompatible with the coating. By using the antifoamer, the solid content of the coating is able to be improved, and the VOCs generated can be reduced. At the same time, the surface tension is reduced during construction of the coating, and bubbles are broken rapidly.

In some embodiments, the antiager includes a UV absorbent and a light stabilizer; in which the UV absorbent is present in a proportion of 0%-3% by weight based on a total weight of the aspartic polyurea coating, and the light stabilizer is present in a proportion of 0%-3% by weight based on the total weight of the aspartic polyurea coating.

In the above technical solutions, by adding the antiager, a more durable light retention and color retention of a topcoat is able to be obtained, and a rapid aging of the coating surface can be prevented.

In some embodiments, the coupling agent is at least one selected from a group consisting of KH-560, KH-570 and KH-602 (commercially available from Dow Chemical Company).

In the above technical solutions, the coupling agent can not only reduce the viscosity of the coating, but also improve an adhesion of the hydrophobic end of the coupling agent to an inorganic metal substrate, increase an adhesion of polyaspartic acid ester to inorganic pigments and fillers, improve a cohesion and strength of the paint film, and thus improve a adhesion of the paint film.

In some embodiments, the diluent comprises 50% of butyl acetate and 50% of 2-acetoxy-1-methoxypropane based on a total weight of the diluent.

In the above technical solutions, by using the diluent, the viscosity is further reduced, especially for a high solid content system of aspartic polyurea, and even 1% of solvent can significantly reduce the viscosity.

In a second aspect, the present application provides a preparation method of an aspartic polyurea coating, including weighing a polyaspartic acid ester, a dispersant, a organotin catalyst, a titanium white powder, a thixotropic agent, a water absorbent, a leveling agent, a antifoamer and a antiager, mixing evenly, then dispersing at a high speed and heating up to 110° C. - 130° C., vacuuming for 30 min - 120 min to obtain a mixed material, adding the coupling agent and the diluent to the mixed material, mixing evenly to form a mixture with component A polyaspartic acid ester as a main body;

stirring the mixture evenly, adding component B, then stirring evenly to form a stable and uniform aspartic polyurea coating.

In some embodiments, a ketoimine is added before or after adding component B.

In some embodiments, before adding the ketoimine to the mixed material, the mixed material is dispersed at a high speed.

In some embodiments, the mixed material is dispersed at 1000-2000 rpm for 10-30 min.

In the above technical solutions, the ketoimine is added with the coupling agent and the diluent after the mixed material is prepared, so as to avoid absorbing water in the mixed material during a production process and a hydrolysis reaction. Further, if a production condition cannot meet a requirement of heating and vacuumizing, the ketoimine also can be used as a separate third component, and added after mixing the mixture and component B evenly and before applying the coating, to avoid losing efficacy due to hydrolysis caused by early water absorption. The speed of high speed dispersion is controlled at 1000-2000 rpm. At this speed, a fineness of the prepared aspartic polyurea coating is less than 30um, which is conducive to maintaining a low viscosity of the coating, improving the appearance of the film and the storage stability of the coating.

In summary, the present application can achieve at least one of the following technical effects.

1. In existing technologies, the aspartic polyurea coating includes a polyaspartic acid ester, a dispersant, titanium white powder, a thixotropic agent, a leveling agent, a antifoamer and an isocyanate curing agent. On this basis, in the present application, a organotin catalyst and a ketoimine are added. First, after adding the ketoimine, a small amount of water brought in can be absorbed, and a long activition period of the aspartic polyurea coating can be maintained. During a construction process, the specific surface area of the coating in contact with the air increases exponentially. The ketoimine in the film is rapidly hydrolyzed with sufficient water in the air to form the polyamines, and the polyamines can react and combined with the isocyanate curing agent quickly, thus accelerating the reaction and improving the drying speed of the coating. Adding only the organotin catalyst to an aspartic polyurea system with F520 as the main body cannot accelerate the drying speed of the coating. However, with a coordination of ketoimine, the organotin catalyst can activate -NCO group of the curing agent, and make a carbon react more actively, and accelerate the reaction with the water, thus the drying speed of a coating surface can be further improved, and a drying time of the formed aspartic polyurea coating does not exceed 5 h. It is verified from the experiment that a 4.5 h of drying time of aspartic polyurea coating is achieved. Second, a dispersant, a coupling agent, a antifoamer, a leveling agent, a antiager and other components are added in the mixture, the coating finally obtained has excellent aging resistance and can be used as a topcoat. Moreover, the coating applied to the surface of the substrate is smooth, flat and bubble-free, and has a good corrosion resistance. Additionally, compared with an existing epoxy coating, the present application obtains a polyaspartic acid ester coating with a solid content of 90%, and the content of VOCs in the solvent is low at the high solid content, which is convenient for an anti-corrosion construction of a large outdoor structure. Finally, because the coating of the present application has a fast drying speed, a low viscosity and a long pot life, there is no need to use an expensive bi-component spraying equipment commonly used in aspartic polyurea, and the construction can be carried out only by using a common airless spraying equipment, which greatly reduces a limitation of a construction equipment and widens its application.

2. By mixing and reaction of the above components, the aspartic polyurea coating with fast drying speed is finally obtained. Meanwhile, the preparation process of this method is simple, has a low cost, needs no large instruments and equipment, and can be applied to an large-scale production.

### BRIEF DESCRIPTION OF THE DRAWINGS

FIG. 1 shows an effect of aging time on a color difference in aging resistance of a coating at 90% solid content in Examples 1-3 and Comparative examples 1-5.

FIG. 2 shows an effect of aging time on a glossiness in aging resistance of the coating at 90% solid content in Examples 1-3 and Comparative examples 1-5.

FIG. 3 shows the effect of aging time on the color difference in aging resistance of the coating at 90% solid content in Examples 4-7.

FIG. 4 shows the effect of aging time on the color difference in aging resistance of the coating at 90% solid content in Example 4 and Comparative Examples 1-5.

FIG. 5 shows the effect of aging time on the glossiness difference in aging resistance of the coating at 90% solid content in Examples 4-7.

FIG. 6 shows the effect of aging time on the glossiness difference in aging resistance of the coating at 90% solid content in Example 4 and Comparative Examples 1-5.

### DETAILED DESCRIPTION

With a spread of environmental protection concepts and policies such as “clear waters and green mountains are as valuable as mountains of gold and silver”, in the coating industry, environmental-friendly coatings are increasingly favored by people, especially an aspartic polyurea coating with high solid content, and the VOCs content thereof is less than 15%, even 0. However, there is a problem that an activation period and drying speed cannot be satisfied simultaneously during a use process of the aspartic polyurea coating.

The inventor found that an factor affecting the activation period and drying speed of the coating is introduction of water during using the coating. Therefore, the inventor tried to add ketoimine into aspartic polyurea coating, in order to extend the activation period of the coating by a hydrolysis of ketoimine, and improve the drying speed of the coating at the same time. After numerous experiments, the activation period was nearly doubled, and the drying time was reduced from 8.2 h to 6.5 h. However, a best drying time of coating stipulated in the coating industry is 2-5 h, and a coating construction and recoalability are good within this time range. Thus, it is necessary to further optimize the experiment to improve the drying speed of the coating. After numerous experiments, the inventor found that adding organotin catalyst can improve the drying speed of the coating, especially when the proportion of polyaspartic acid ester, ketoimine and organotin catalyst was strictly controlled, the drying speed of the coating can be less than 5 h, which meets a standard of high quality coating.

The present application is further described in detailed in combination with tables and Examples.

### Components and Their Corresponding Models

Dispersant: BYK163 (commercially available from BYK-Chemie GmbH);
Titanium white powder: R606 (commercially available from NINGBO XINFU TITANIUM DIOXIDE CO., LTD);
Thixotropic agent: fumed silica;
Water absorbent: 3A molecular sieve;
Leveling agent: EFKA3600 (commercially available from BASF);
Antifoamer: BYK085 (commercially available from BYK-Chemie GmbH);
UV absorbent: 1130 (commercially available from BASF);
Light stabilizer: 292 (commercially available from BASF);
Coupling agent: KH-560 (commercially available from Dow Chemical Company);
Ketimine: IPDA ketoimine (commercially available from Shenzhen Feiyang Protech Corp., Ltd).

### EXAMPLES

Component B isocyanate curing agent adopts HDI trimer, in which the isocyanate curing agent added was controlled at an amount such that an amount of isocyanate groups in the isocyanate curing agent can completely react with the secondary amine group of polyaspartic acid ester and a primary amine group after ketoimine hydrolysis in the coating. In an actual application, an excessive addition of isocyanate can ensure a complete reaction of the secondary amine group of polyaspartic acid ester and the primary amine group after ketoimine hydrolysis. The amount of isocyanate groups can be controlled as 1.05-1.5 times of a total amount of the secondary amine group of polyaspartic acid ester and the primary amine group after ketoimine hydrolysis.

TABLE 1

weight percentage of each component of the mixture with component A polyaspartic acid ester as main body in Examples 1-3 and Comparative Examples 1-5

| | Example 1 | Example 2 | Example 3 | Comparative example 1 | Comparative example 2 | Comparative example 3 | Comparative example 4 | Comparative example 5 |
|---|---|---|---|---|---|---|---|---|
| Polyaspartic acid ester F520 | 36% | 48% | 60% | 36% | 36% | 36% | 36% | 78% |
| Polyaspartic acid ester F2850 | 0 | 0 | 0 | 0% | 0% | 0% | 0% | 0 |
| Ketoimine | 6% | 4% | 4% | 0 | 10% | 4% | 4% | 8% |
| Organotin catalyst | 0.15% | 0.20% | 0.20% | 0.10% | 0.20% | 0 | 0.30% | 0 |
| Dispersant | 1% | 1% | 1% | 1% | 1% | 1% | 1% | 1% |
| Titanium white powder | 43% | 33% | 23% | 48% | 39% | 45% | 45% | 0 |
| Thixotropic agent | 0.30% | 0.30% | 0.30% | 0.30% | 0.30% | 0.30% | 0.20% | 0 |
| 3A molecular sieve | 3% | 3% | 1% | 3% | 3% | 3% | 3% | 0 |
| Leveling agent | 0.10% | 0.10% | 0.10% | 0.30% | 0.10% | 0.30% | 0.10% | 0.20% |
| Antifoamer | 0.25% | 0.20% | 0.20% | 1% | 0.20% | 0.20% | 0.20% | 0.40% |
| UV absorbent | 2% | 2% | 2% | 2% | 2% | 2% | 2% | 2% |
| Light stabilizer | 1% | 1% | 1% | 1% | 1% | 1% | 1% | 1% |
| Coupling agent | 1% | 1% | 1% | 1% | 1% | 1% | 1% | 1% |
| 2-Acetoxy-1-met hoxypropane | 3.10% | 3.10% | 3.10% | 3.10% | 3.10% | 3.10% | 3.10% | 4.20% |
| Butyl acetate | 3.10% | 3.10% | 3.10% | 3.10% | 3.10% | 3.10% | 3.10% | 4.20% |
| Total | 100% | 100% | 100% | 100% | 100% | 100% | 100% | 100% |

In Examples 1-2, the aspartic polyurea coatings were prepared by the following method:

polyaspartic acid ester F520, dispersant, organotin catalyst, titanium white powder, thixotropic agent, water absorbent, leveling agent, antifoamer, UV absorbent, light stabilizer were weighed and undergone a manual low speed mixing. Then, a dispersion was conducted in a high speed disperser with a rotational speed of 1500 rpm for 8 min, and a mixed material were obtained. Then, the mixed material was poured into a reactor with heating and vacuumizing functions. The reactor was heated to 120° C. and vacuumized to remove water at the same time for 60 min. Then, the coupling agent, 2-acetoxy-1-methoxypropane, butyl acetate and ketoimine were added under stirring at a low speed, and mixed evenly to obtain a mixture with component A polyaspartic acid ester as the main body.

Before using the coating, the mixture were stirred evenly, into which the component B was added and stirred evenly to obtain a stable and uniform aspartic polyurea coating.

In Examples 3 and Comparative examples 1-5, the aspartic polyurea coatings were prepared by the following method:

polyaspartic acid ester F520, dispersant, organotin catalyst, titanium white powder, thixotropic agent, water absorbent, leveling agent, antifoamer, UV absorbent, light stabilizer were weighed and undergone a manual low speed mixing. Then, a dispersion was conducted in a high speed disperser with a rotational speed of 1500 rpm for 8 min, and a mixed material were obtained. Then, the mixed material was poured into a reactor with heating and vacuumizing functions. The reactor was heated to 120° C. and vacuumized to remove a water at the same time for 60 min. Then, the coupling agent, 2-acetoxy-1-methoxypropane and butyl acetate were added under stirring at a low speed, and mixed evenly to obtain a mixture with component A polyaspartic acid ester as the main body.

Before using the coating, the mixture were stirred evenly, into which the component B and the ketoimine were successively added and stirred evenly to obtain a stable and uniform aspartic polyurea coating.

### Performance Analysis

TABLE 2

drying time of the coating at 90% solid content in Examples 1-3 and Comparative examples 1-5

| Examples | Example 1 | Example 2 | Example 3 | Comparative example 1 | Comparative example 2 | Comparative example 3 | Comparative example 4 | Comparative example 5 |
|---|---|---|---|---|---|---|---|---|
| Dry to touch/h | 4 | 4.1 | 4.3 | 8 | 1.8 | 6.5 | 6.1 | 5 |

It is stipulated in the coating industry when the drying time of the coating is 2-5 h, the drying speed is appropriate, and the prepared coating is a high quality coating.

In table 2, in Examples 1-3, the polyaspartic acid ester F520 was used, the ketoimine and the organotin catalyst were both added. In Comparative example 1, the ketoimine was not added, but the organotin catalyst was added. In Comparative example 2, an excessive amount of ketoimine and a proper amount of organotin catalyst were added. The dry to touch time of Examples 1-3 were less than 5 h, which meets the standard of high quality coating. However, the dry to touch time of Comparative example 1 was 8 h, and the dry to touch time of Comparative example 2 was 1.8 h, both of which fail to meet the standard of high quality coating.

In Examples 1-3, the organotin catalyst was added. In Comparative example 3, the organotin catalyst was not added. In Comparative example 4, the organotin catalyst was added excessively. The dry to touch time of Examples 1-3 were not greater than 4.3 h, and the drying time is short, so the coating of Examples 1-3 were high quality coating. However, the dry to touch time of Comparative examples 3-4 were greater than 5 h, and coating properties were poor.

Comparing Example 1, Comparative example 3 and Comparative example 5, in Comparative example 3, the ketoimine was added, but the organotin catalyst was not added. For Comparative example 5 as varnish, only the ketoimine was added, but the organotin catalyst was not added. After a test, it can be seen that the dry to touch time was 6.5 h, and there was no change due to a difference of main components of the coating.

TABLE 3

the activation period of the coating at 90% solid content in Examples 1-3 and Comparative examples 1-5

| Examples | Example 1 | Example 2 | Example 3 | Comparative example 1 | Comparative example 2 | Comparative example 3 | Comparative example 4 | Comparative example 5 |
|---|---|---|---|---|---|---|---|---|
| Activation period/min | 150 | 155 | 157 | 55 | 155 | 136 | 163 | 139 |

As can be seen from table 1 and table 3, no ketoimine was added in Comparative example 1, but the ketoimine was added in other Examples and Comparative examples. The activation period of Comparative example 1 was only 55 min, and the activation periods of other Examples and Comparative examples were greater than 60 min.

It is stipulated in the coating industry when a color difference is less than 3.0, an aging resistance of the coating is level 1 that is better.

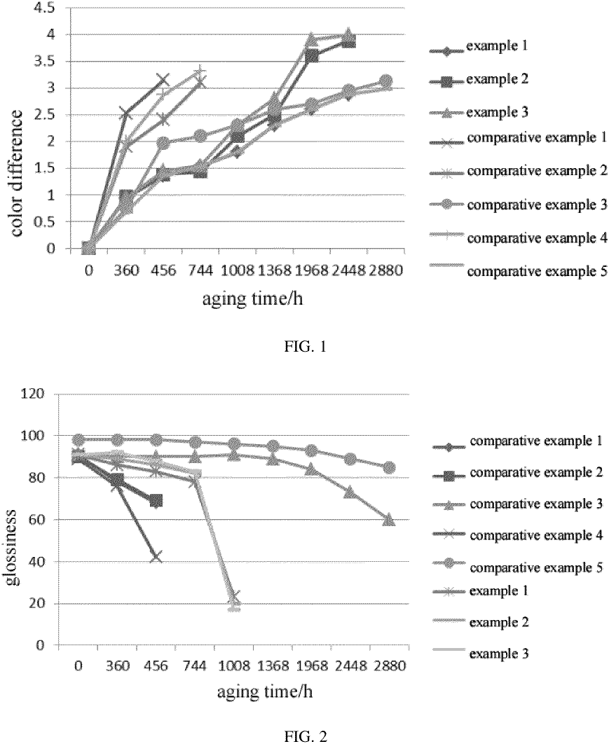

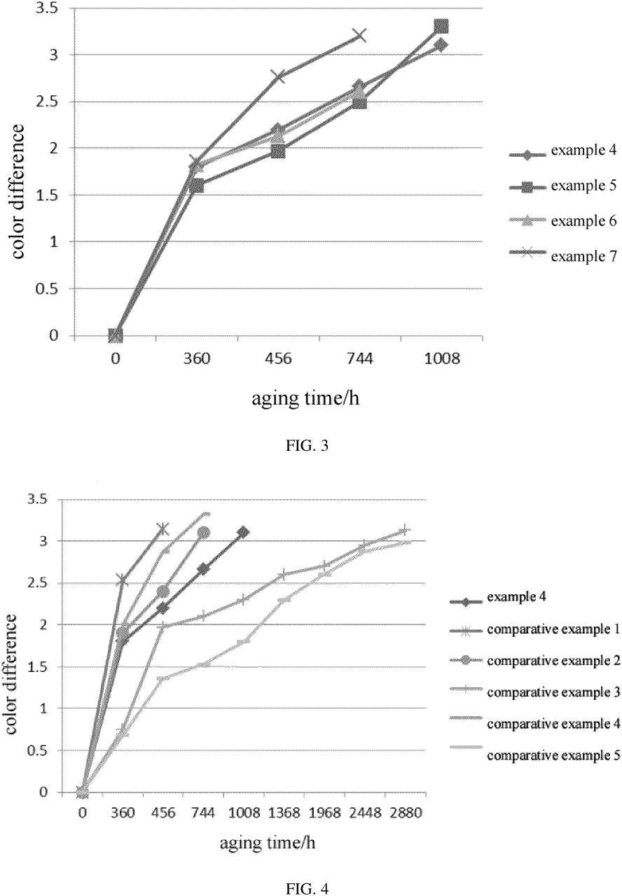

In combination with Examples 1-3, Comparative examples 1-5 and FIG. 1, in Examples 1-3, the ketoimine was added, and the color difference was less than 3.0 within 744 h. No ketoimine was added in Comparative example 1, and excessive amount of ketoimine was added in Comparative example 2, which affected the color difference, and the color difference exceeded 3.0 when the aging time was 456 h.

In combination with Examples 1-3, Comparative examples 3-4 and FIG. 1, the catalyst and the ketoimine were added in Examples 1-3, no organotin catalyst was added in Comparative example 3, and excessive amount of organotin catalyst was added in Comparative example 4. It can be seen from FIG. 1 that, there was substantially no difference between a color difference change of Comparative example 3 and that of Examples 1-3, and the color difference of Comparative example 4 exceeded 3.0 at 744 h.

In combination with Examples 1-3 and Comparative example 5, the coating in Comparative example 5 was varnish, and the coatings in Examples 1-3 were common coating. It can be seen from FIG. 1 that, under a condition of the same aging time, the color difference of Comparative example 5 was not higher than those of Examples 1-3.

It can be seen from FIG. 2 that, with an extension of aging time, a glossiness decreases rapidly in Examples 1-3, and the glossiness was lower than 40 at 1008 h. In Comparative example 1-2, the amount of the ketoimine added was changed, but there was substantially no difference in terms of a change of glossiness. In Comparative example 3, no organotin catalyst was added, the glossiness thereof had little change with the extension of aging time. In Comparative example 4, excessive amount of organotin catalyst was added, the glossiness thereof changed fast with the extension of aging time, and was close to 40 at 456 h. The coating in Comparative example 5 was varnish, and the glossiness thereof was better and still exceeded 80 even at 2880 h.

TABLE 4

weight percentage of each component of the mixture with component A polyaspartic acid ester as main body in Examples 4-7

| | Example 4 | Example 5 | Example 6 | Example 7 |
|---|---|---|---|---|
| Polyaspartic acid ester F520 | 32% | 46% | 52% | 32% |
| Polyaspartic acid ester F2850 | 4% | 2% | 8% | 4% |
| IPDA ketoimine | 4% | 8% | 4% | 4% |
| Organotin catalyst | 0.20% | 0.10% | 0.10% | 0.20% |
| Dispersant | 1% | 1% | 1% | 1% |
| Titanium white powder | 45% | 29% | 26% | 48% |
| Thixotropic agent | 0.30% | 0.30% | 0.30% | 0.30% |
| 3A molecular sieve | 3% | 3% | 2% | 3% |
| Leveling agent | 0.10% | 0.20% | 0.20% | 0.10% |
| Antifoamer | 0.20% | 0.20% | 0.20% | 0.20% |
| UV absorbent | 2% | 2% | 2% | 0 |
| Light stabilizer | 1% | 1% | 1% | 0 |
| Coupling agent | 1% | 1% | 1% | 1% |
| 2-Acetoxy-1-methoxypropane | 3.10% | 3.10% | 1.10% | 3.10% |
| Butyl acetate | 3.10% | 3.10% | 1.10% | 3.10% |
| Total | 100% | 100% | 100% | 100% |

The preparation methods of aspartic polyurea coating in Examples 4-7 were same as that in Examples 1-2.

### Performance Analysis

TABLE 5

drying time of coating at 90% solid content in Examples 4-6

| Examples | Example 4 | Example 5 | Example 6 | Example 7 |
|---|---|---|---|---|
| Dry to touch/h | 3.3 | 3.8 | 5.8 | 3.5 |

In Examples 4-7, the polyaspartic acid ester F520 and F2850 were used. It can be seen from table 5 that, when the polyaspartic acid ester F520 and F2850 were used together, the drying time of the prepared aspartic polyurea coating was shorter. In particular, when a weight ratio of the polyaspartic acid ester F520 to F2850 was 8:1 (corresponding to Examples 4), it was shown in FIG. 1 that the drying time was shorter, and the drying speed was faster.

TABLE 6

activation period of coating at 90% solid content in Examples 4-6

| Examples | Example 4 | Example 5 | Example 6 | Example 7 |
|---|---|---|---|---|
| Activation period/min | 160 | 145 | 65 | 134 |

In Example 4, the weight ratio of polyaspartic acid ester F520 to F2850 was 8:1, and the activation period was up to 160 min. In Example 5, the weight ratio of polyaspartic acid ester F520 to F2850 was 23:1, and the activation period was 145 min. In Example 6, the amount of polyaspartic acid ester F2850 added was 8% by weight, but the activation period of the prepared coating was only 65 min. In Example 7, no UV absorbent and no light stabilizer were added, the activation period was 134 min. The activation period of Example 4 was the longest in the Examples of the present application.

In Examples 4-7, the polyaspartic acid ester was F520 and F2850. The color difference was not less than 2.5 at 774 h. In Example 7, no UV absorbent and no light stabilizer was added, the color difference was greater than 3.0 when the aging time was 722 h.

In combination with FIG. 4, Example 4 and Comparative examples 1-2, in Example 4, the ketoimine and the organotin catalyst were added; in Comparative example 1, no ketoimine was added; in Comparative example 2, excessive amount of ketoimine was added. It can be seen from FIG. 4 that, the color difference of Example 4 was greater than 2.5 when the aging time was 744 h, but the color differences of Comparative example 1 and Comparative example 2 were greater than 3.

In combination with Example 4 and Comparative examples 3-4, in Example 4, the ketoimine and the organotin catalyst were added; in Comparative examples 3-4, the ketoimine was added; however, in Comparative example 3, no organotin catalyst was added; in Comparative example 4, excessive amount of organotin catalyst was added. When the aging time was 744 h, the color difference of Example 4 was greater than 2.5, but the color difference of Comparative example 3 was less than 2.5, the aging resistance is level 1, and the color difference of Comparative example 4 was close to 3.5.

In combination with Example 4 and Comparative example 5, it can be seen from FIG. 4 that, the coating in Comparative example 5 was varnish, and the color difference thereof was still less than 3 when the aging time was 2448 h.

It can be seen that, the aging resistance of Example 4 was average, and it is more suitable to be used as a DTM single coating that does not require a durable weather resistance situation, but requires corrosion and weather resistance at the same time but the requirements are not high, or as a primer or an intermediate coating.

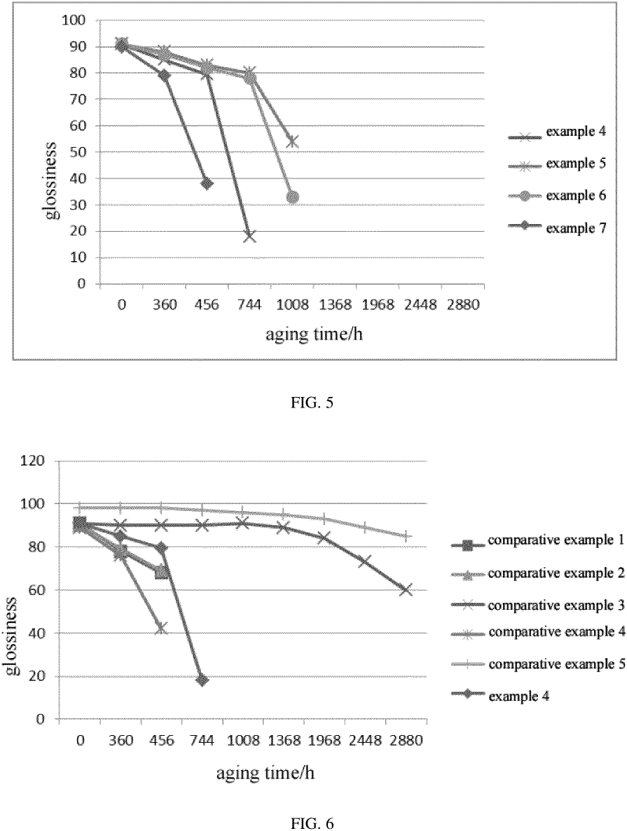

It can be seen from FIG. 5 that, with the extension of aging time, the glossiness of Examples 4-7 decreases fastest, in which Example 7 was the most obvious. At 456 h, the glossiness of Example 4 was still close to 80, but at 744 h, the glossiness was less than 20. That is, a glossiness change rate was very fast.

It can be seen from FIG. 6 that, when the aging time was less than 360 h, the glossiness of Example 4 and Comparative examples 1-5 were all greater than 80. With the extension of aging time, the glossiness of Example 4, Comparative examples 1-2 and 4 decreases rapidly. In particular, the glossiness of Example 4 was less than 20 at 744 h. Thus, the coating prepared in the present application was easy to lose gloss in a long time, and was more suitable for being used as a primer or an intermediate coating.

In summary, when the ketoimine and organotin catalyst were added to the aspartic polyurea system at the same time, the drying speed of the coating was fast, the time period was shortened to 3.3 h, and the activation period was long. However, when the polyaspartic acid ester of the coating was a composite component, that is, including F520 and F2850 at the same time, the glossiness and the color difference of the coating were easy to change, which was more suitable for being used as a primer or an intermediate coating.

The above are the preferred embodiments of the present application, which are not intended to limit the protection scope of the present application. Therefore, all equivalent changes made according to the structure, shape and principle of the present application should be covered within the protection scope of the present application.

What is claimed is:

1. An aspartic polyurea coating, comprising a mixture and an isocyanate curing agent, wherein the mixture comprises the following components by weight:
a polyaspartic acid ester: 36%-60%; a ketoimine: 4%-8%; a dispersant: 0.5%-1.0%; an organotin catalyst: 0.1%-0.2%; a titanium white powder: 0%-48%; a thixotropic agent: 0.2%-1.0%; a leveling agent: 0.05%-0.3%; an antifoamer: 0.1%-1.0%; an antiager: 0%-3.0%; a coupling agent: 0%-5%; and a diluent: 0%-10%, based on a total weight of the mixture; and
the mixture further comprises a water absorbent being present in a proportion of 1%-3% by weight based on a total weight of the aspartic polyurea coating.

2. The aspartic polyurea coating according to claim 1, wherein, the polyaspartic acid ester comprises F520 and F2850; F520 is present in a proportion of 32%-60% by weight based on the total weight of the aspartic polyurea coating; F2850 is present in a proportion of no greater than 4% by weight based on the total weight of the aspartic polyurea coating.

3. The aspartic polyurea coating according to claim 1, wherein, the ketoimine is prepared by condensation of a ketone and a polyamine, and the polyamine is at least one selected from a group consisting of 4,4′-diaminodicyclohexylmethane, 3,3′dimethyl-4,4′-diaminodicyclohexylmethane, 1,5-diamino-2-methylpentane, isophorondiamine, 4-methylcyclohexane-1,3-diamine and polyetheramine D230.

4. The aspartic polyurea coating according to claim 1, wherein, the dispersant is at least one selected from a group consisting of an anionic dispersant, a cationic dispersant, a non-ionic dispersant, a zwitterionic wetting dispersant, an electrically neutral wetting dispersant, a polymer hyperdispersant and a free radical hyperdispersant.

5. The aspartic polyurea coating according to claim 1, wherein, the thixotropic agent is at least one selected from a group consisting of fumed silica, organic bentonite, castor oil and polyamide.

6. The aspartic polyurea coating according to claim 1, wherein, the antiager comprises an ultraviolet (UV) absorbent and a light stabilizer; and wherein the UV absorbent is present in a proportion of 0%-3% by weight based on the total weight of the aspartic polyurea coating, and the light stabilizer is present in a proportion of 0%-3% by weight based on the total weight of the aspartic polyurea coating.

7. The aspartic polyurea coating according to claim 1, wherein, the diluent comprises 50% of butyl acetate and 50% of 2-acetoxy-1-methoxypropane based on a total weight of the diluent.
